(19) United States
(12) Patent Application Publication
(10) Pub. No.: US 2024/0265642 A1
(43) Pub. Date: Aug. 8, 2024

(54) REDUCING A MEASURE OF A COGNITIVE STATE OF AN INDIVIDUAL IN AN ENVIRONMENT TO BE LESS THAN A CAUSE-FOR-CONCERN THRESHOLD

(71) Applicant: Toyota Motor Engineering & Manufacturing North America, Inc., Plano, TX (US)

(72) Inventors: Benjamin Piya Austin, Saline, MI (US); Joshua E. Domeyer, Madison, WI (US); Heishiro Toyoda, Mountain View, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/105,507

(22) Filed: Feb. 3, 2023

(51) Int. Cl. G06T 19/00; B60W 30/12; B60W 30/16; B60W 40/08

(52) U.S. Cl. CPC G06T 19/006; B60W 30/12; B60W 30/16; B60W 40/08; B60W 2540/22

(57) ABSTRACT

A system for reducing a measure of a cognitive state of an individual in an environment to be less than a cause-for-concern threshold can include a processor and a memory. The memory can store an analysis module and a controller module. The analysis module can cause the processor to obtain information that the measure of the cognitive state of the individual in the environment is greater than the cause-for-concern threshold. The controller module can cause the processor to cause a response intended to reduce the measure to be less than the cause-for-concern threshold. The response can include one or more of: (1) a presentation of an image to produce an augmented reality for the environment or (2) if the individual is operating a machine, then a change to an operation of: (a) a component of a stationary machine or (b) a movement control component of a machine configured to move.

### TECHNICAL FIELD

The disclosed technologies are directed to systems, methods, and computer program products to reduce a measure of a cognitive state of an individual in an environment to be less than a cause-for-concern threshold.

### BACKGROUND

A cognitive state of an individual in an environment can change. Such a change can give rise to a cause for concern. For example, the cause for concern can be a reason to worry. For example, such a cognitive state can include a degree of inattentiveness, a degree of fatigue, a degree of timidity, a degree of apprehension, or the like. For example, such a change in the cognitive state can occur based on a degree of familiarity of the individual with the environment, in response to the individual having been in the environment for a continuous duration of time that is greater than a threshold continuous duration of time, or the like. For example, the individual in the environment can be a pedestrian in an environment that includes traffic, a worker operating a machine in a manufacturing environment, an operator of a machine configured to move, or the like. For example, a machine configured to move can be a vehicle. If a measure of the cognitive state of the individual in the environment is greater than a cause-for-concern threshold, then a likelihood that the individual will be involved in a harmful incident may increase.

### SUMMARY

In an embodiment, a system for reducing a measure of a cognitive state of an individual in an environment to be less than a cause-for-concern threshold can include a processor and a memory. The memory can store an analysis module and a controller module. The analysis module can include instructions that, when executed by the processor, cause the processor to obtain information indicative that the measure of the cognitive state of the individual in the environment is greater than the cause-for-concern threshold. The controller module can include instructions that, when executed by the processor, cause the processor to cause a response intended to reduce the measure to be less than the cause-for-concern threshold. The response can include one or more of: (1) a presentation of an image to produce an augmented reality for the environment or (2) if the individual is operating a machine, then a change to an operation of: (a) a component of a stationary machine or (b) a movement control component of a machine configured to move.

In another embodiment, a method for reducing a measure of a cognitive state of an individual in an environment to be less than a cause-for-concern threshold can include obtaining, by a processor, information indicative that the measure of the cognitive state of the individual in the environment is greater than the cause-for-concern threshold. The method can include causing, by the processor, a response intended to reduce the measure to be less than the cause-for-concern threshold. The response can include one or more of: (1) a presentation of an image to produce an augmented reality for the environment or (2) if the individual is operating a machine, then a change to an operation of: (a) a component of a stationary machine or (b) a movement control component of a machine configured to move.

In another embodiment, a non-transitory computer-readable medium for reducing a measure of a cognitive state of an individual in an environment to be less than a cause-for-concern threshold can include instructions that, when executed by one or more processors, cause the one or more processors to obtain information indicative that the measure of the cognitive state of the individual in the environment is greater than the cause-for-concern threshold. The non-transitory computer-readable medium can also include instructions that, when executed by one or more processors, cause the one or more processors to cause a response intended to reduce the measure to be less than the cause-for-concern threshold. The response can include one or more of: (1) a presentation of an image to produce an augmented reality for the environment or (2) if the individual is operating a machine, then a change to an operation of: (a) a component of a stationary machine or (b) a movement control component of a machine configured to move.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 includes a diagram that illustrates a first example of an environment for reducing a measure of a cognitive state of an individual in an environment to be less than a cause-for-concern threshold, according to the disclosed technologies.

FIG. 2 includes a block diagram that illustrates an example of a system for reducing a measure of a cognitive state of an individual in an environment to be less than a cause-for-concern threshold, according to the disclosed technologies.

FIG. 3 includes a diagram that illustrates a second example of the environment for reducing the measure of the cognitive state of the individual in the environment to be less than the cause-for-concern threshold, according to the disclosed technologies.

FIG. 4 includes a diagram that illustrates a third example of the environment for reducing the measure of the cognitive state of the individual in the environment to be less than the cause-for-concern threshold, according to the disclosed technologies.

FIG. 5 includes a diagram that illustrates an example of a vehicle which can be configured to reduce the measure of the cognitive state of the individual in the environment to be less than the cause-for-concern threshold, according to the disclosed technologies.

FIG. 6 includes a diagram that illustrates a fourth example of the environment for reducing the measure of the cognitive state of the individual in the environment to be less than the cause-for-concern threshold, according to the disclosed technologies.

FIG. 7 includes a flow diagram that illustrates an example of a method that is associated with reducing a measure of a cognitive state of an individual in an environment to be less than a cause-for-concern threshold, according to the disclosed technologies.

FIG. 8 includes a block diagram that illustrates an example of elements disposed on a vehicle, according to the disclosed technologies.

### DETAILED DESCRIPTION

The disclosed technologies are directed to reducing a measure of a cognitive state of an individual in an environment to be less than a cause-for-concern threshold. For example, a cognitive state can include a degree of inattentiveness, a degree of fatigue, a degree of timidity, a degree of apprehension, or the like. For example, a change in the cognitive state can occur based on a degree of familiarity of the individual with the environment, in response to the individual having been in the environment for a continuous duration of time that is greater than a threshold continuous duration of time, or the like. For example, the individual in the environment can be a pedestrian in an environment that includes traffic, a worker operating a machine in a manufacturing environment, an operator of a machine configured to move, or the like. Information indicative that the measure of the cognitive state of the individual in the environment is greater than the cause-for-concern threshold can be obtained. A response intended to reduce the measure to be less than the cause-for-concern threshold can be caused. For example, the response can include a presentation of an image to produce an augmented reality for the environment. Additionally or alternatively, for example, if the individual is operating a machine, then the response can include a change to an operation of either a component of a stationary machine or a movement control component of a machine configured to move. For example, a stationary machine can be a machine that, during an operation of the machine for which the machine was designed, remains at a same location. For example, a machine configured to move can be a vehicle.

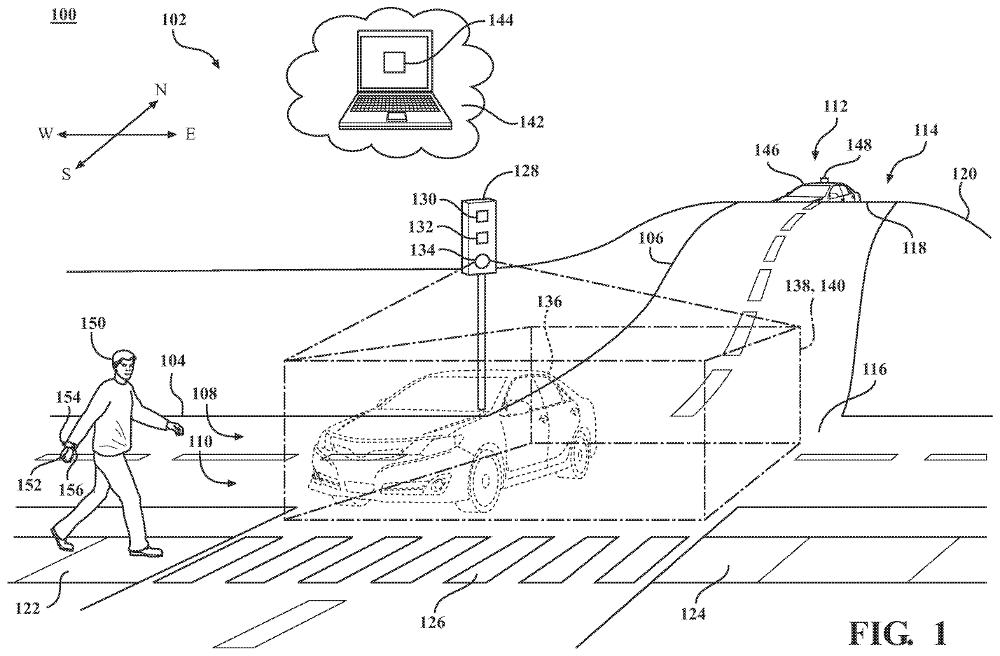

FIG. 1 includes a diagram that illustrates a first example 102 of an environment 100 for reducing a measure of a cognitive state of an individual in an environment to be less than a cause-for-concern threshold, according to the disclosed technologies. The first example 102 can include a first road 104 (disposed along a line of latitude) and a second road 106 (disposed along a line of longitude). The first road 102 can include, for example, a lane 108 for westbound traffic and a lane 110 for eastbound traffic. The second road 104 can include, for example, a lane 112 for southbound traffic and a lane 114 for northbound traffic. An intersection 116 can be formed by the first road 104 and the second road 106. The second road 106 can be disposed along a crest 118 of a hill 120 north of the intersection 116. A first sidewalk 122 can be disposed south of the first road 104 west of the intersection 116 and a second sidewalk 124 can be disposed south of the first road 104 cast of the intersection 116. A crosswalk 126 can be disposed across the second road 106 south of the intersection 116 and between the first sidewalk 122 and the second sidewalk 124. The first example 102 can include, at a northwest corner of the intersection 116, a roadside unit 128. For example, the roadside unit 128 can include a communications device 130, a controller 132, and a projector 134. For example, the controller 132 can be configured to control an appearance of an image 136 to be projected by the projector 134 to a display region 138 at the intersection 116. For example, the display region 138 can be a volume of space 140 and the image 136 can have a three-dimensional form. The first example 102 can include a cloud computing platform 142. For example, the cloud computing platform 142 can include a communications device 144. A vehicle 146 can be located in the lane 112 just beyond the crest 118 of the hill 120. For example, the vehicle 146 can include a communications device 148. An individual 150 can be located on the first sidewalk 122 just west of the crosswalk 126. The individual 150 can be wearing a wearable wireless activity tracker 152. For example, the wearable wireless activity tracker 152 can be configured to monitor steps taken by the individual 150, heart rate, sleep quality, or the like. For example, the wearable wireless activity tracker 152 can include a sensor 154 and a communications device 156. The sensor 154 can be configured to determine a current location of the wearable wireless activity tracker 152. For example, the sensor 154 can be a Global Navigation Satellite System (GNSS) sensor.

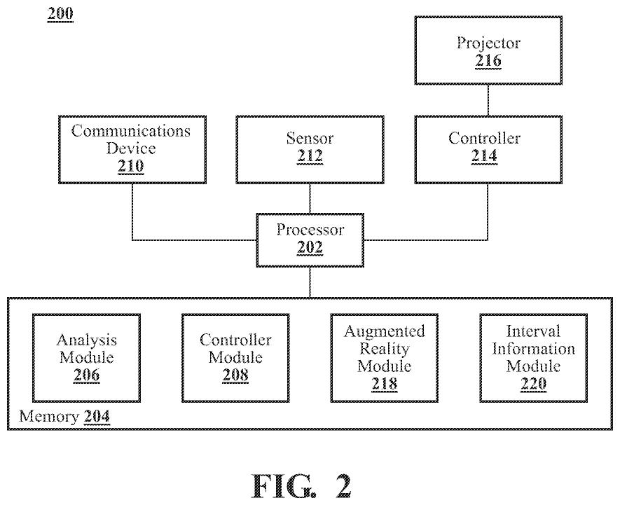

FIG. 2 includes a block diagram that illustrates an example of a system 200 for reducing a measure of a cognitive state of an individual in an environment to be less than a cause-for-concern threshold, according to the disclosed technologies. The system 200 can include, for example, a processor 202 and a memory 204. The memory 204 can be communicably coupled to the processor 202. For example, the memory 204 can store an analysis module 206 and a controller module 208.

For example, the analysis module 206 can include instructions that function to control the processor 202 to obtain information indicative that the measure of the cognitive state of the individual in the environment is greater than the cause-for-concern threshold.

For example, the controller module 208 can include instructions that function to control the processor 202 to cause a response intended to reduce the measure to be less than the cause-for-concern threshold. The response can include a presentation of an image to produce an augmented reality for the environment. Additionally or alternatively, for example, if the individual is operating a machine, then the response can include a change to an operation of either a component of a stationary machine or a movement control component of a machine configured to move.

For example, the system 200 can further include a communications device 210. The communications device 210 can be communicably coupled to the processor 202.

For example, the system 200 can further include a sensor 212, a controller 214, and a projector 216. The sensor 212 can be communicably coupled to the processor 202. The sensor 212 can be configured to obtain information indicative of a cognitive state of an individual. For example, the sensor 212 can include one or more of a gaze-tracking system, a still image camera, a video camera, an infrared camera, or the like. Additionally or alternatively, for example, the sensor 212 can be configured to monitor blood pressure, heart rate, oxygen saturation, electrical conductance of skin, or the like from a hand in contact with the sensor 212. The controller 214 can be communicably coupled to the processor 202. The projector 216 can be communicably coupled to the controller 214. For example, the controller 214 can be configured to control an appearance of an image to be projected by the projector 216.

In a first implementation, for example, the individual can be a pedestrian. The environment can be an environment that includes traffic. For example, the measure of the cognitive state can be a measure of one or more of a degree of inattentiveness, a degree of fatigue, or the like. For example, the instructions to obtain the information can include instructions to receive, from the communications device 210, the information. Additionally or alternatively, for example, the instructions to obtain the information can include instructions to determine that a continuous duration of time that the individual has been traversing the environment as the pedestrian is greater than a threshold continuous duration of time. The continuous duration of time can end at a current time. For example, the instruction to cause the response can include instructions to cause a communication to be sent to a roadside unit, in a vicinity of the individual, to cause the roadside unit to produce the presentation of the image to produce the augmented reality for the environment.

With reference to FIGS. 1 and 2, for example, the system 200 can be disposed on the roadside unit 128. For example, the individual 150 can be a pedestrian. The first example 102 of the environment 100 can include traffic. For example, information monitored by the wearable wireless activity tracker 152 can be communicated by the communications device 156, included in the wearable wireless activity tracker 152, to the communications device 144 included in the cloud computing platform 142. The cloud computing platform 142 can determine, based on the information monitored by the wearable wireless activity tracker 152, that one or more of the measure of the degree of inattentiveness, the measure of the degree of fatigue, or the like of the individual 150 is greater than a cause-for-concern threshold. The information indicative that the measure of the cognitive state of the individual 150 is greater than the cause-for-concern threshold can be communicated by the communications device 144, included in the cloud computing platform 142, to the communications device 130 (which can be the communications device 210) included in the roadside unit 128.

Additionally or alternatively, for example, the sensor 154 (e.g., the Global Navigation Satellite System (GNSS) sensor) included in the wearable wireless activity tracker 152 can produce determinations of locations of the individual 150. For example, such determinations can be produced periodically. Such determinations about the locations of the individual 150 can be communicated by the communications device 156, included in the wearable wireless activity tracker 162, to the communications device 144 included in the cloud computing platform 142. The cloud computing platform 142 can determine, based on the determinations about the locations of the individual 150, that: (1) the continuous duration of time that the individual 150 has been traversing the first example 102 of the environment 100 as the pedestrian is, for example, three hours and (2) the roadside unit 128 is in a vicinity of a current location of the individual 150. A determination that the continuous duration of time that the individual 150 has been traversing the first example 102 of the environment 100 as the pedestrian is three hours can be communicated by the communications device 144, included in the cloud computing platform 142, to the communications device 130 (which can be the communications device 210) included in the roadside unit 128.

For example, one or more of: (1) the information indicative that the measure of the cognitive state of the individual 150 is greater than the cause-for-concern threshold or (2) the determination that the continuous duration of time that the individual 150 has been traversing the first example 102 of the environment 100 as the pedestrian is three hours can be received by the communications device 130 (which can be the communications device 210) included in the roadside unit 128. If: (1) the roadside unit 128 receives the determination that the continuous duration of time that the individual 150 has been traversing the first example 102 of the environment 100 as the pedestrian is three hours and (2) the threshold continuous duration of time is, for example, two hours, then the cloud computing platform 142 can determine that the continuous duration of time that the individual 150 has been traversing the first example 102 of the environment 100 as the pedestrian is greater than the threshold continuous duration of time. In response to one or more of: (1) a receipt of the information indicative that the measure of the cognitive state of the individual 150 is greater than the cause-for-concern threshold or (2) a determination that the continuous duration of time that the individual 150 has been traversing the first example 102 of the environment 100 as the pedestrian is greater than the threshold continuous duration of time, the roadside unit 128 can be caused to produce the presentation of the image 136 to produce the augmented reality for the first example 102 of the environment 100. For example, the controller 132, included in the roadside unit 128, can control the appearance of the image 136 to be projected by the projector 134, included in the roadside unit 128, to the display region 138 at the intersection 116. For example, the appearance of the image 136 can be a vehicle.

Additionally, for example, the communications device 130 (which can be the communications device 210), included in the roadside unit 128, can receive from the communications device 148, included in the vehicle 146, information about a current location of the vehicle 146 and a current speed of the vehicle 146. The roadside unit 128 can calculate, based on a current location of the individual 150, the current location of the vehicle 146, and the current speed of the vehicle 146, that a probability that both the individual 150 and the vehicle 146 will be located at the crosswalk 126 at a same time is greater than a probability threshold. In response to one or more of: (1) (a) the receipt of the information indicative that the measure of the cognitive state of the individual 150 is greater than the cause-for-concern threshold and (b) the probability that both the individual 150 and the vehicle 146 will be located at the crosswalk 126 at the same time is greater than the probability threshold or (2) (a) the determination that the continuous duration of time that the individual 150 has been traversing the first example 102 of the environment 100 as the pedestrian is greater than the threshold continuous duration of time and (b) the probability that both the individual 150 and the vehicle 146 will be located at the crosswalk 126 at the same time is greater than the probability threshold, the roadside unit 128 to produce the presentation of the image 136 to produce the augmented reality for the first example 102 of the environment 100.

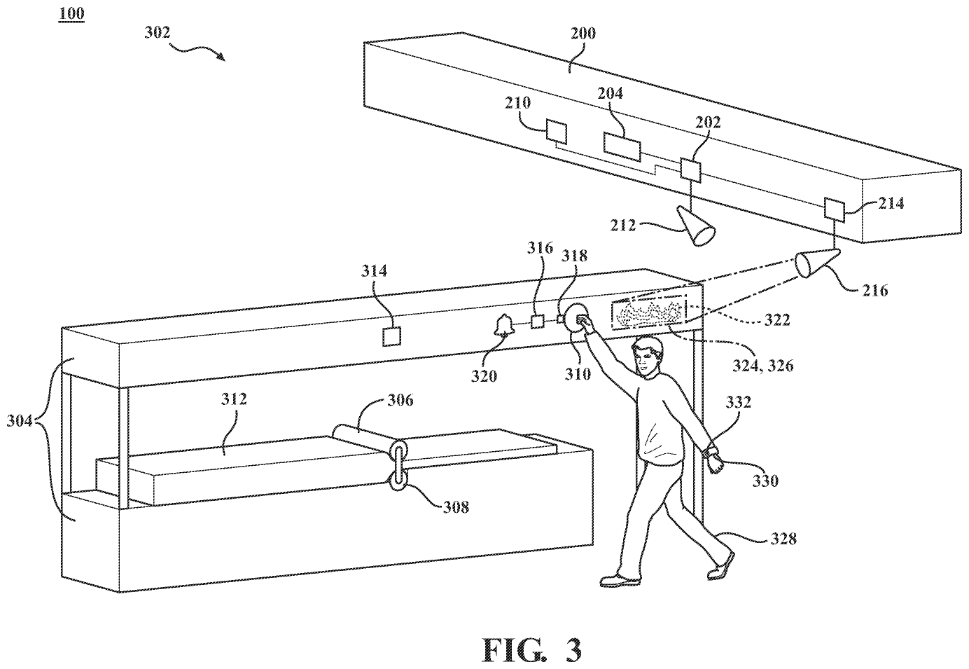

FIG. 3 includes a diagram that illustrates a second example 302 of the environment 100 for reducing the measure of the cognitive state of the individual in the environment to be less than the cause-for-concern threshold, according to the disclosed technologies. The second example 302 of the environment 100 can be a site of a stationary machine 304 in a manufacturing environment. For example, the stationary machine 304 can include a first roller 306, a second roller 308, and a component 310. For example, the stationary machine 304 can be configured to reduce a thickness of a workpiece 312 that passes between the first roller 306 and the second roller 308. For example, the component 310 can be configured to control an operation of the stationary machine 304. For example, the stationary machine 304 can include a communications device 314, a controller 316, a haptic actuator 318, and a sound actuator 320. For example, the haptic actuator 318 can be disposed on the component 310. For example, the sound actuator 320 can be one or more of a bell, a buzzer, or the like. For example, the controller 316 can be configured to control an activation of one or more of the haptic actuator 318 or the sound actuator 320. The second example 302 can include a second implementation of the system 200. The second implementation of the system 200 can include the communications device 210, the sensor 212, the controller 214, and the projector 216. The sensor 212 can be configured to obtain information indicative of a cognitive state of an individual. For example, the sensor 212 can include one or more of a gaze-tracking system, a still image camera, a video camera, an infrared camera, or the like. For example, the controller 214 can be configured to control an appearance of an image 322 to be projected by the projector 216 to a display region 324 of the stationary machine 304. For example, the display region 324 can have a flat surface 326 and the image 322 can have a two-dimensional form. In the second example 302, an individual 328 can be located at the site of the stationary machine 304. The individual 328 can be wearing a wearable wireless activity tracker 330. For example, the wearable wireless activity tracker 330 can be configured to monitor steps taken by the individual 328, heart rate, sleep quality, or the like. For example, the wearable wireless activity tracker 330 can include a communications device 332.

With reference to FIG. 2, in a second implementation, for example, the individual can be a worker operating a stationary machine. The environment can be a site of the stationary machine in a manufacturing environment. For example, the measure of the cognitive state can be a measure of one or more of a degree of inattentiveness, a degree of fatigue, or the like. For example, the instructions to obtain the information can include instructions to receive, from the communications device 210, the information. Additionally or alternatively, for example, the instructions to obtain the information can include instructions to determine, from an analysis of data received from the sensor 212, the information. Additionally or alternatively, for example, the instructions to obtain the information can include instructions to determine that a continuous duration of time that the individual has been operating the stationary machine is greater than a threshold continuous duration of time. The continuous duration of time can end at a current time. For example, the instruction to cause the response can include instructions to cause a communication to be sent to the projector 216, which is in a vicinity of the individual, to cause the projector 216 to produce the presentation of the image to produce the augmented reality for the environment. Additionally or alternatively, for example, the instruction to cause the response can include instructions to cause the change to the operation of the component of the stationary machine.

With reference to FIGS. 2 and 3, for example, the individual 328 can be a worker operating the stationary machine 304. The second example 302 of the environment 100 can be a site of the stationary machine 304 in a manufacturing environment. For example, information monitored by the wearable wireless activity tracker 330 can be communicated by the communications device 332, included in the wearable wireless activity tracker 330, to the communications device 210 included in the system 200. The system 200 can determine, based on the information monitored by the wearable wireless activity tracker 330, that one or more of the measure of the degree of inattentiveness, the degree of fatigue, or the like of the individual 328 is greater than a cause-for-concern threshold.

Additionally or alternatively, for example, data obtained by the sensor 212 (e.g., one or more of a gaze-tracking system, a still image camera, a video camera, an infrared camera, or the like) can be analyzed to determine that one or more of the measure of the degree of inattentiveness, the measure of the degree of fatigue, or the like of the individual 328 is greater than the cause-for-concern threshold.

Additionally or alternatively, for example the system 200 can determine (e.g., from an analysis of the data obtained by the sensor 212) that the continuous duration of time that the individual 328 has been operating the stationary machine 304 is, for example, five hours. If the threshold continuous duration of time is, for example, four hours, then the system 200 can determine that the continuous duration of time that the individual 328 has been operating the stationary machine 304 is greater than the threshold continuous duration of time.

In response to one or more of: (1) a receipt of the information indicative that the measure of the cognitive state of the individual 328 is greater than the cause-for-concern threshold or (2) a determination that the continuous duration of time that the individual 328 has been operating the stationary machine 304 is greater than the threshold continuous duration of time, the system 200 can be caused to one or more of: (1) produce the presentation of the image 322 to produce the augmented reality for the second example 302 of the environment 100 or (2) change the operation of the component 310 of the stationary machine 304. For example, the controller 214, included in the system 200, can control the appearance of the image 322 to be projected by the projector 216, included in the system 200, to the display region 324 of the stationary machine 304. For example, the appearance of the image 322 can be flames. Additionally or alternatively, for example, a communication can be communicated by the communications device 210, included in the system 200, to the communications device 314 included in the stationary machine 304. The communication can cause the controller 316 to control the activation of one or more of the haptic actuator 318 or the sound actuator 320.

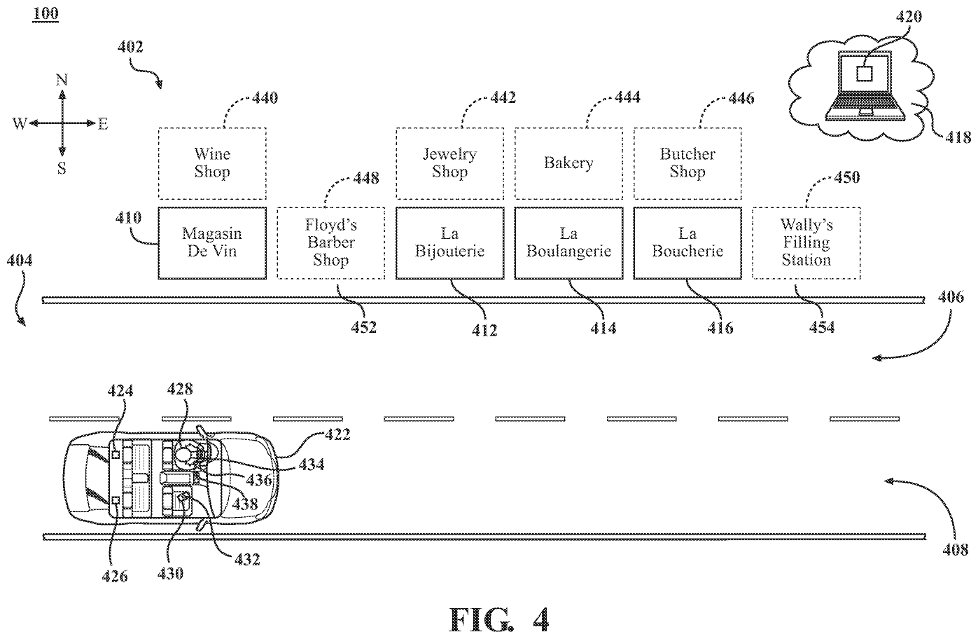

FIG. 4 includes a diagram that illustrates a third example 402 of the environment 100 for reducing the measure of the cognitive state of the individual in the environment to be less than the cause-for-concern threshold, according to the disclosed technologies. The third example 402 of the environment 100 can be in France. The third example 402 can include a road 404 (disposed along a line of latitude). The road 404 can include, for example, a lane 406 for westbound traffic and a lane 408 for eastbound traffic. Buildings north of the road 404 can include, from west to cast, a first building 410, Magasin de Vin; a second building 412, La Bijouterie; a third building 414, La Boulangerie; and a fourth building 416, La Boucherie. The third example 402 can include a cloud computing platform 418. For example, the cloud computing platform 418 can include a communications device 420. A vehicle 422 can be located at a west end of the road 404 in the lane 408. For example, the vehicle 422 can include a sensor 424 and a communications device 426. The sensor 424 can be configured to determine a current location of the vehicle 422. For example, the sensor 424 can be a Global Navigation Satellite System (GNSS) sensor. An individual 428 can be within the vehicle 422 as an operator of the vehicle 422 and can be causing the vehicle 422 to move cast within the lane 408. The individual 428 can possess a cell phone 430 located on or near the individual 428. For example, the cell phone 430 can include a sensor 432. The sensor 432 can be configured to determine a current location of the cell phone 430. For example, the sensor 432 can be a Global Navigation Satellite System (GNSS) sensor. The individual 428 can be wearing a wearable wireless activity tracker 434. For example, the wearable wireless activity tracker 434 can be configured to monitor steps taken by the individual 428, heart rate, sleep quality, or the like. For example, the wearable wireless activity tracker 434 can include a sensor 436 and a communications device 438. The sensor 436 can be configured to determine a current location of the wearable wireless activity tracker 434. For example, the sensor 436 can be a Global Navigation Satellite System (GNSS) sensor. For example, the individual 428 can be from Mayberry, North Carolina in the United States. This can be a first visit by the individual 428 to France.

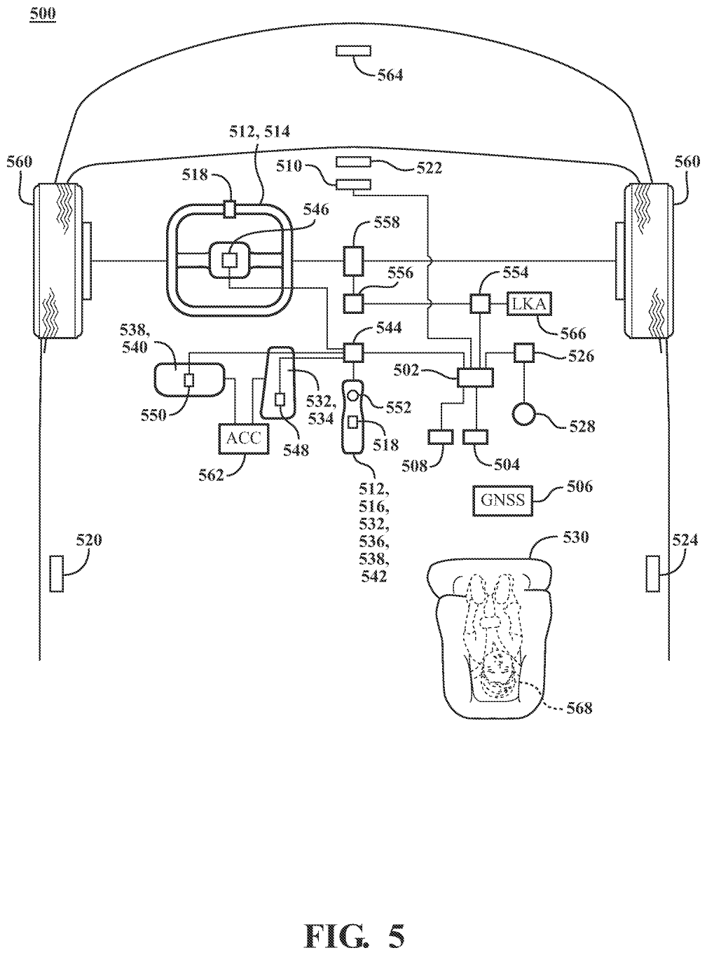

FIG. 5 includes a diagram that illustrates an example of a vehicle 500 which can be configured to reduce the measure of the cognitive state of the individual in the environment to be less than the cause-for-concern threshold, according to the disclosed technologies. The vehicle 500 can include, for example, a processor 502, a memory 504, a sensor 506, and a communications device 508. The memory 504 can be communicably coupled to the processor 502. The sensor 506 can be configured to determine a current location of the vehicle 500. For example, the sensor 506 can be a Global Navigation Satellite System (GNSS) sensor. The communications device 508 can be communicably coupled to the processor 502.

Additionally, for example, the vehicle 500 can further include a sensor 510. The sensor 510 can be communicably coupled to the processor 502. The sensor 510 can be configured to obtain information indicative of a cognitive state of an individual operating the vehicle 500. For example, the sensor 510 can include one or more of a gaze-tracking system, a still image camera, a video camera, an infrared camera, or the like.

Additionally, for example, the vehicle 500 can include a steering operator interface 512. In a first example 514, the steering operator interface 512 can be a steering wheel, a handlebar, a twin lever steering interface, or the like. In a second example 516, the steering operator interface 512 can be a joystick-like control lever or the like. For example, a sensor 518 can be disposed on the steering operator interface 512. For example, the sensor 518 can be configured to monitor blood pressure, heart rate, oxygen saturation, electrical conductance of skin, or the like from a hand in contact with the sensor 518.

Additionally, for example, the vehicle 500 can include a left side-facing camera 520, a forward-facing camera 522, and a right side-facing camera 524.

Additionally, for example, the vehicle 500 can include a controller 526 and a projector 528. The controller 526 can be communicably coupled to the processor 502. The projector 528 can be communicably coupled to the controller 526. For example, the controller 526 can be configured to control an appearance of an image to be projected by the projector 528.

Additionally, for example, a child safety seat 530 can be installed in the vehicle 500.

Additionally, for example, the vehicle 500 can include an accelerating operator interface 532. In a first example 534, the accelerating operator interface 532 can be an accelerator pedal. In a second example 536, the accelerating operator interface 532 can be the joystick-like control lever.

Additionally, for example, the vehicle 500 can include a braking operator interface 538. In a first example 540, the braking operator interface 538 can be a brake pedal. In a second example 542, the braking operator interface 538 can be the joystick-like control lever.

Additionally, for example, the vehicle 500 can include a controller 544 and one or more of a steering operator interface haptic actuator 546, an accelerating operator interface haptic actuator 548, a braking operator interface haptic actuator 550, or a joystick-like control lever haptic actuator 552. The controller 544 can be communicably coupled to the processor 502. The one or more of the steering operator interface haptic actuator 546, the accelerating operator interface haptic actuator 548, the braking operator interface haptic actuator 550, or the joystick-like control lever haptic actuator 552 can be communicably coupled to the controller 544.

Additionally, for example, the vehicle 500 can include a controller 554 and an actuator 556. The controller 554 can be communicably coupled to the processor 502. The actuator 556 can be communicably coupled to the controller 554. The actuator 556 can be coupled to a steering mechanism 558. The steering mechanism 558 can be coupled between the steering operator interface 512 and one or more wheels 560 of the vehicle 500.

Additionally, for example, the vehicle 500 can include an adaptive cruise control (ACC) system 562 and a sensor 564. The adaptive cruise control (ACC) system 562 can be communicably coupled to the processor 502, the accelerating operator interface 532, and the braking operator interface 538. The sensor 564 can be configured to determine a distance between the vehicle 500 and an object in front of the vehicle 500. For example, the sensor 564 can be a ranging device. For example, the ranging device can be one or more of a radar device, a lidar device, an ultrasonic ranging device, an infrared ranging device, or the like.

Additionally, for example, the vehicle 500 can include a lane keeping assist (LKA) system 566. The lane keeping assist (LKA) system 566 can be communicably coupled to the processor 502 and the steering mechanism 558.

With reference to FIG. 2, in a third implementation, for example, the machine configured to move can be a vehicle and the individual can be an operator of the vehicle. The environment can be a location for which a degree of familiarity, of the individual, is less than a threshold degree of familiarity. For example, the measure of the cognitive state can be a measure of one or more of a degree of timidity, a degree of apprehension, or the like. For example, the instructions to obtain the information can include instructions to receive, from the communications device 210, the information. Additionally or alternatively, for example, the instructions to obtain the information can include instructions to determine, from an analysis of data received from the sensor 212, the information. For example, the instruction to cause the response can include instructions to cause a communication to be sent to the projector 216, disposed on the vehicle, to cause the projector 216 to produce the presentation of the image to produce the augmented reality for the environment.

With reference to FIGS. 2, 4, and 5, for example, the system 200 can be disposed on the vehicle 422 (which can be the vehicle 500). For example, the machine configured to move can be the vehicle 422 and the individual 428 can be an operator of the vehicle 422. The third example 402 of the environment 100 can be a location (i.e., France) for which a degree of familiarity, of the individual 428, is less than a threshold degree of familiarity. For example, historical information about locations of the cell phone 430 (which can be a proxy for historical information about locations of the individual 428), produced by the sensor 432 (e.g., the GNSS sensor) included in the cell phone 430, can be communicated to the communications device 420, included in the cloud computing platform 418, and communicated by the communications device 420 to the communications device 210 (which can be the communications device 508) included in the system 200. The system 200 can compare the historical information about the locations of the cell phone 430 with historical information about locations of the vehicle 422 (which can be the vehicle 500), produced by the sensor 506 (e.g., the GNSS sensor) and determine that the degree of familiarity, of the individual 428, is less than the threshold degree of familiarity.

For example, information monitored by the wearable wireless activity tracker 434 can be communicated by the communications device 438, included in the wearable wireless activity tracker 434, to the communications device 420 included in the cloud computing platform 418. The cloud computing platform 418 can determine, based on the information monitored by the wearable wireless activity tracker 434, that one or more of the measure of the degree of timidity, the measure of the degree of apprehension, or the like of the individual 428 is greater than a cause-for-concern threshold. The information indicative that the measure of the cognitive state of the individual 428 is greater than the cause-for-concern threshold can be communicated by the communications device 420, included in the cloud computing platform 418, to the communications device 210 included in the system 200.

Additionally or alternatively, for example, data obtained by the sensor 212 (which can be one or more of the sensor 510 (e.g., one or more of a gaze-tracking system, a still image camera, a video camera, an infrared camera, or the like) or the sensor 518 (e.g., configured to monitor blood pressure, heart rate, oxygen saturation, electrical conductance of skin, or the like from a hand in contact with the sensor 518)) can be analyzed to determine that one or more of the measure of the degree of timidity, the measure of the degree of apprehension, or the like of the individual 428 is greater than the cause-for-concern threshold.

In response to a receipt of the information indicative that the measure of the cognitive state of the individual 428 is greater than the cause-for-concern threshold, the system 200 can be caused to produce the presentation of the image to produce the augmented reality for the third example 402 of the environment 100.

For example, the controller 214 (which can be the controller 526), included in the system 200, can control the appearance of one or more images 440, 442, 444, 446, 448, or 450 to be projected by the projector 216 (which can be the projector 528), included in the system 200, to produce the augmented reality for the third example 402 of the environment 100. For example, using the left side-facing camera 520, the system 200 can: (1) acquire images of signs for the first building 410, Magasin de Vin; the second building 412, La Bijouterie; the third building 414, La Boulangerie; and the fourth building 416, La Boucherie, (2) translate phrases on the signs from French to English, and (3) project, as the augmented reality for the third example 402 of the environment 100, one or more of an image 440, Wine Shop; an image 442, Jewelry Shop; an image 444, Bakery; or an image 446, Butcher Shop. Additionally or alternatively, for example, using the left side-facing camera 520, the system 200 can: (1) determine that: (a) a first vacant lot 452 exists between the first building 410 and the second building 412 and (b) a second vacant lot 454 exists cast of the fourth building 416 and (2) project, as the augmented reality for the third example 402 of the environment 100, one or more of: (a) an image 448 of Floyd's Barber Shop (from Mayberry) or (b) an image 450 of Wally's Filling Station (from Mayberry).

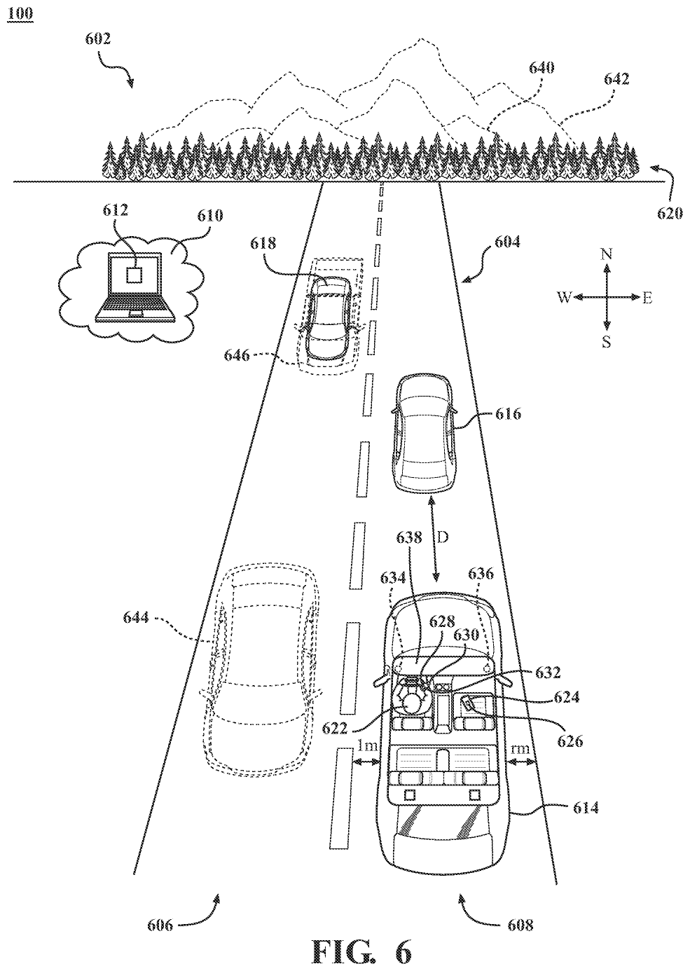

FIG. 6 includes a diagram that illustrates a fourth example 602 of the environment 100 for reducing the measure of the cognitive state of the individual in the environment to be less than the cause-for-concern threshold, according to the disclosed technologies. The fourth example 602 can include a road 604 (disposed along a line of longitude). The road 604 can include, for example, a lane 606 for southbound traffic and a lane 608 for northbound traffic. The fourth example 602 can include a cloud computing platform 610. For example, the cloud computing platform 610 can include a communications device 612. The fourth example 602 can include a first vehicle 614, a second vehicle 616, and a third vehicle 618. The first vehicle 614 can be located in the lane 608 and can be moving north at one hundred kilometers per hour. The second vehicle 616 can be located in the lane 608 at a distance D in front of the first vehicle 614 and can be moving north at one hundred kilometers per hour. The third vehicle 618 can be located in the lane 606 about one kilometer in front of the first vehicle 614 and can be moving south. In the fourth example 602, a line of trees 620 can be present at a distant horizon in front of the first vehicle 614. An individual 622 can be within the first vehicle 614 as an operator of the first vehicle 614 and can be causing the first vehicle 614 to move north within the lane 608. The individual 622 can possess a cell phone 624 located on or near the individual 622. For example, the cell phone 624 can include a sensor 626. The sensor 626 can be configured to determine a current location of the cell phone 624. For example, the sensor 626 can be a Global Navigation Satellite System (GNSS) sensor. The individual 622 can be wearing a wearable wireless activity tracker 628. For example, the wearable wireless activity tracker 628 can be configured to monitor steps taken by the individual 622, heart rate, sleep quality, or the like. For example, the wearable wireless activity tracker 628 can include a sensor 630 and a communications device 632. The sensor 630 can be configured to determine a current location of the wearable wireless activity tracker 628. For example, the sensor 630 can be a Global Navigation Satellite System (GNSS) sensor.

With reference to FIG. 2, in a fourth implementation, for example, the machine configured to move can be a vehicle and the individual can be an operator of the vehicle. The environment can be a location for which a degree of familiarity, of the individual, is greater than a threshold degree of familiarity. For example, the measure of the cognitive state can be a measure of one or more of a degree of inattentiveness, a degree of fatigue, or the like. For example, the instructions to obtain the information can include instructions to receive, from the communications device 210, the information. Additionally or alternatively, for example, the instructions to obtain the information can include instructions to determine, from an analysis of data received from the sensor 212, the information. Additionally or alternatively, for example, the instructions to obtain the information can include instructions to determine, based on a result of a performance of a test, the information. Additionally or alternatively, for example, the instructions to obtain the information can include instructions to determine that a continuous duration of time that the individual has been operating the vehicle at the location is greater than a threshold continuous duration of time. The continuous duration of time can end at a current time. For example, the instruction to cause the response can include instructions to cause a communication to be sent to the projector 216, disposed on the vehicle, to cause the projector 216 to produce the presentation of the image to produce the augmented reality for the environment. Additionally or alternatively, for example, the instruction to cause the response can include instructions to cause the change to the operation of the movement control component of the vehicle.

With reference to FIGS. 2, 5, and 6, for example, the system 200 can be disposed on the first vehicle 614 (which can be the vehicle 500). For example, the machine configured to move can be the first vehicle 614 and the individual 622 can be an operator of the first vehicle 614. The fourth example 602 of the environment 100 can be a location for which a degree of familiarity, of the individual 622, is greater than a threshold degree of familiarity. For example, historical information about locations of the cell phone 624 (which can be a proxy for historical information about locations of the individual 622), produced by the sensor 626 (e.g., the GNSS sensor) included in the cell phone 624, can be communicated to the communications device 612, included in the cloud computing platform 610, and communicated by the communications device 612 to the communications device 210 (which can be the communications device 508) included in the system 200. The system 200 can compare the historical information about the locations of the cell phone 624 with historical information about locations of the first vehicle 614 (which can be the vehicle 500), produced by the sensor 506 (e.g., the GNSS sensor) and determine that the degree of familiarity, of the individual 622, is greater than the threshold degree of familiarity.

For example, information monitored by the wearable wireless activity tracker 628 can be communicated by the communications device 632, included in the wearable wireless activity tracker 628, to the communications device 612 included in the cloud computing platform 610. The cloud computing platform 610 can determine, based on the information monitored by the wearable wireless activity tracker 628, that one or more of the measure of the degree of inattentiveness, the measure of the degree of fatigue, or the like of the individual 622 is greater than a cause-for-concern threshold. The information indicative that the measure of the cognitive state of the individual 622 is greater than the cause-for-concern threshold can be communicated by the communications device 612, included in the cloud computing platform 610, to the communications device 210 included in the system 200.

Additionally or alternatively, for example, data obtained by the sensor 212 (which can be one or more of the sensor 510 (e.g., one or more of a gaze-tracking system, a still image camera, a video camera, an infrared camera, or the like) or the sensor 518 (e.g., configured to monitor blood pressure, heart rate, oxygen saturation, electrical conductance of skin, or the like from a hand in contact with the sensor 518)) can be analyzed to determine that one or more of the measure of the degree of inattentiveness, the measure of the degree of fatigue, or the like of the individual 622 is greater than the cause-for-concern threshold.

Additionally or alternatively, for example, the system 200 can cause a gaze tracking test to be performed and can determine, based on a result of a performance of the gaze tracking test, that one or more of the measure of the degree of inattentiveness, the measure of the degree of fatigue, or the like of the individual 622 is greater than the cause-for-concern threshold. For example, the controller 214 (which can be the controller 526), included in the system 200, can control the appearance of one or more images 634 or 636 to be projected by the projector 216 (which can be the projector 528), included in the system 200, to perform the gaze tracking test. For example, one or more of: (1) an image 634 can be projected to an upper left corner of a windshield 638 of the first vehicle 614 or (2) an image 636 can be projected to an upper right corner of the windshield 638. For example, data obtained by the sensor 212 (which can be the sensor 510 (e.g., a gaze-tracking system)) can be analyzed to determine one or more of: (1) if a gaze of the individual 622 changed to observe one or more of the image 634 or the image 636 or (2) a response time of the individual 622 in observing one or more of the image 634 or the image 636. The system 200 can determine, based on the result of the performance of the gaze tracking test, that one or more of the measure of the degree of inattentiveness, the measure of the degree of fatigue, or the like of the individual 622 is greater than the cause-for-concern threshold.

Additionally or alternatively, for example the system 200 can determine (e.g., from an analysis of the data obtained by the sensor 212 (which can be the sensor 510 (e.g., a video camera)) that the continuous duration of time that the individual 622 has been operating the first vehicle 614 is, for example, five hours. If the threshold continuous duration of time is, for example, four hours, then the system 200 can determine that the continuous duration of time that the individual 622 has been operating the first vehicle 614 is greater than the threshold continuous duration of time.

In response to one or more of: (1) a receipt of the information indicative that the measure of the cognitive state of the individual 622 is greater than the cause-for-concern threshold or (2) a determination that the continuous duration of time that the individual 622 has been operating the first vehicle 614 is greater than the threshold continuous duration of time, the system 200 can be caused to one or more of: (1) in a first variation, produce the presentation of the image to produce the augmented reality for the fourth example 602 of the environment 100 or (2) in a second variation, change the operation of the movement control component of the first vehicle 614.

In the first variation, for example, the controller 214 (which can be the controller 526), included in the system 200, can control the appearance of an image 640 to be projected by the projector 216 (which can be the projector 528), included in the system 200, to produce the augmented reality for the fourth example 602 of the environment 100. For example, using the forward-facing camera 522, the system 200 can: (1) acquire an image of the line of trees 620 present at the distant horizon and (2) project, as the augmented reality for the fourth example 602 of the environment 100, the image 640. For example, the appearance of the image 640 can be a range of mountains.

In a first realization of the first variation, for example, the memory 204 can further store an augmented reality module 218. The augmented reality module 218 can include instructions that function to control the processor 202 to determine a characteristic of the image. For example, the characteristic can be one or more of a type, a size, a position in the environment of an appearance of the image, or the like. For example, a purpose for a projection of an image to produce an augmented reality can be to make an environment appear less familiar to an individual so that the individual will pay attention to the environment. However, this purpose can be undermined if an appearance of the image causes the image to be a distraction for the individual. For this reason, the one or more characteristics of the image can be determined so that the appearance of the image, at least initially, is relatively inconspicuous. For example, the position in the environment of the image can be near a horizon.

In an extension of the first realization of the first variation, for example, the image can include a sequence of images. For example, a characteristic of a later image, in the sequence of images, can be different from a characteristic of an earlier image in the sequence of images.

For example, if a presentation of the earlier image does not improve an attentiveness of the individual to the environment, the later image, having one or more characteristics that are different from the one or more characteristics of the earlier image, can be presented. With reference to FIG. 6, for example, the image 640 can be the earlier image and an image 642 can be the later image. A size of the image 642 can be larger than a size of the image 640. Additionally or alternatively, a position of the image 642, in the fourth example 602 of the environment 100, can be closer to the first vehicle 614 than a position of the image 640 in the fourth example 602 of the environment 100.

In a second realization of the first variation, for example, the image to produce the augmented reality for the environment can include an image that causes another vehicle to appear to be in a vicinity of the vehicle. For example, the image to produce the augmented reality for the fourth example 602 of the environment 100 can be an image 644, which is an image of another vehicle in the vicinity of the first vehicle 614.

In a third realization of the first variation, for example, the environment can include another vehicle in a vicinity of the vehicle and the image to produce the augmented reality for the environment can include an image that causes an appearance of the other vehicle to be larger than an actual size of the other vehicle. For example, the fourth example 602 of the environment 100 can include the third vehicle 618 and the image to produce the augmented reality for the fourth example 602 of the environment 100 can be an image 646 that causes the appearance of the third vehicle 618 to be larger than the actual size of the third vehicle 618.

In a fourth realization of the first variation, for example, the vehicle can have a child safety seat and the image to produce the augmented reality for the environment can include an image of a child in the child safety seat. With reference to FIG. 5, for example, the projector 216 (which can be the projector 528), included in the system 200, can be configured to produce the presentation of the image to produce the augmented reality within a cabin of the first vehicle 614 (which can be the vehicle 500). For example, the image to produce the augmented reality can be an image 568 of a child in the child safety seat 530.

Additionally or alternatively, in the second variation, for example, the system 200 can be caused to change the operation of the movement control component of the first vehicle 614 (which can be the vehicle 500).

In a first realization of the second variation, for example, the change to the operation of the movement control component of the vehicle can include a production of a vibration at an operator interface of the movement control component. For example, the operator interface can include a steering operator interface, an accelerating operator interface, a braking operator interface, or the like. For example, the steering operator interface can include a steering wheel, a handlebar, a twin lever steering interface, a joystick-like control lever, or the like. For example, the accelerating operator interface can include an accelerator pedal, a joystick-like control lever, or the like. For example, the braking operator interface can include a brake pedal, a joystick-like control lever, or the like. With reference to FIG. 5, for example, the controller 544 (which can be the controller 214) can control an activation of one or more of the steering operator interface haptic actuator 546, the accelerating operator interface haptic actuator 548, the braking operator interface haptic actuator 550, or the joystick-like control lever haptic actuator 552. For example, a purpose for a production of a vibration at an operator interface of the movement control component can be to make the operator interface appear to respond as though the vehicle 500 (which can be the first vehicle 614) was traversing an unfamiliar, bumpy road rather than actually traversing a familiar, smooth road (e.g., the road 604).

In an extension of the first realization of the second variation, for example, a characteristic of the vibration can change with time. For example, the characteristic can include one or more of a rate of the vibration, an amount of energy in the vibration, or the like. For example, the change can be an increase of the characteristic. For example, if a production of the vibration, having an initial characteristic, at the operator interface of the movement control component does not improve an attentiveness of the individual to the environment, then a vibration having a characteristic that is different from the initial characteristic can be produced.

In a second realization of the second variation, for example, the change to the operation of the movement control component of the vehicle can include one or more of a change to a steering torque feedback or a change to a steering ratio.

For example, with respect to the change to the steering torque feedback, a power assist steering mechanism (e.g., the steering mechanism 558) can be connected to the steering operator interface 512 and can act to add to or subtract from torque conveyed through the one or more mechanisms of the steering operator interface 512 to assist the individual in operating the steering operator interface 512. For example, the power assist steering mechanism can be an electric power assist steering mechanism. For example, one or more of the controller 554 (which can be the controller 214) or the actuator 556 can be associated with the power assist steering mechanism or the electric power assist steering mechanism.

For example, with respect to the change to the steering ratio, the change to the steering ratio can be produced by a variable-ratio steering mechanism, an adaptive steering mechanism, an active steering mechanism, a steering effort control module, or the like. For example, one or more of the controller 554 (which can be the controller 214) or the actuator 556 can be associated with one or more of the variable-ratio steering mechanism, the adaptive steering mechanism, the active steering mechanism, the steering effort control module, or the like. Additionally, for example, the actuator 556 can be associated with one or more of a motor, a worm gear, a toothed gear, or the like.

In an extension of the second realization of the second variation, for example, one or more of the change to the steering torque feedback or the change to the steering ratio can change with time. For example, one or more of the change to the steering torque feedback or the change to the steering ratio can decrease with time. Alternatively, for example, one or more of the change to the steering torque feedback or the change to the steering ratio can increase with time. For example, initially, one or more of the change to the steering torque feedback or the change to the steering ratio can be set to a value different from a normal value and can change to the normal value with time. Alternatively, for example, one or more of the change to the steering torque feedback or the change to the steering ratio can be set to a normal value can change to a value different from the normal value with time.

In a third realization of the second variation, for example, the vehicle can have an adaptive cruise control (ACC) system and the change to the operation of the movement control component of the vehicle can include a change, in response to a communication sent to a controller of the adaptive cruise control (ACC) system, to a distance of a gap maintained between the vehicle and a preceding vehicle. For example, initially, the distance D between the first vehicle 614 (which can be the vehicle 500) and the second vehicle 616 can be sixty meters, which can be determined by the sensor 564 (e.g., the ranging device). In response to a communication sent to the adaptive cruise control (ACC) system 562, the adaptive cruise control (ACC) system 562 can control one or more of the accelerating operator interface 532 or the braking operator interface 538 to cause the distance D between the first vehicle 614 and the second vehicle 616 to be forty meters, as determined by the sensor 564 (e.g., the ranging device).

In a fourth realization of the second variation, for example, the vehicle can have a lane keeping assist (LKA) system and the change to the operation of the movement control component of the vehicle can include a change, in response to a communication sent to a controller of the lane keeping assist (LKA) system, to a degree of variation of a lateral position, within a lane, maintained by the lane keeping assist system. For example, initially, the first vehicle 614 (which can be the vehicle 500) can be at a location in the lane 608 that is within a decimeter of a centerline of the lane 608, as maintained by the lane keeping assist (LKA) system 566, so that each of a left margin (lm), between a left edge of the lane 608 and a left side of the first vehicle 614, and a right margin (rm), between a right edge of the lane 608 and a right side of the first vehicle 614, can be between four and five decimeters. In response to a communication sent to the lane keeping assist (LKA) system 566, the lane keeping assist (LKA) system 566 can control the steering mechanism 558 to cause each of the left margin (lm) and the right margin (rm) to be between three and five decimeters.

With reference to FIG. 2, in a fifth implementation, for example: (1) a first time can be a time at which the measure of the cognitive state of the individual in the environment becomes greater than the cause-for-concern threshold, (2) a second time can be a time at which the response is initiated, and (3) an interval can be a duration of time between the first time and the second time.

Additionally, for example, the memory 204 can further store an interval information module 220. The interval information module 220 can include instructions that function to control the processor 202 to obtain information indicative of a measure of the interval. For example, the measure of the interval can be personalized for the individual.

For example, the instructions to obtain the information indicative of the measure of the interval can include instructions to receive, from a computing platform via the communications device 210, the information indicative of the measure of the interval. For example, the computing platform can be a cloud computing platform. For example, the cloud computing platform can be configured to store information personalized for the individual. For example, such information can include the information indicative of the measure of the interval.

Additionally or alternatively, for example, the instructions to obtain the information indicative of the measure of the can interval include instructions to determine, using a machine learning technique, the information indicative of the measure of the interval. For example, the machine learning technique can process information personalized for the individual to determine the measure of the interval.

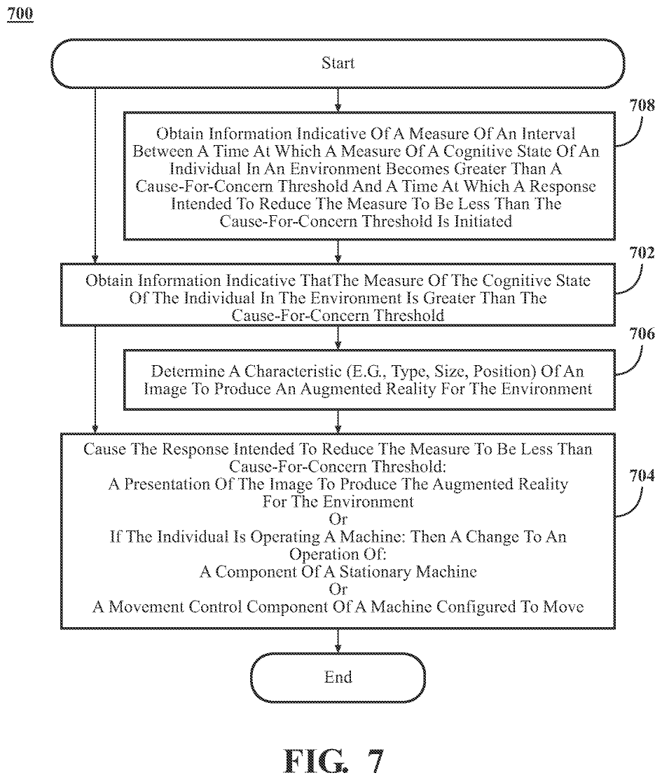

FIG. 7 includes a flow diagram that illustrates an example of a method 700 that is associated with reducing a measure of a cognitive state of an individual in an environment to be less than a cause-for-concern threshold, according to the disclosed technologies. Although the method 700 is described in combination with the system 200 illustrated in FIG. 2, one of skill in the art understands, in light of the description herein, that the method 700 is not limited to being implemented by the system 200 illustrated in FIG. 2. Rather, the system 200 illustrated in FIG. 2 is an example of a system that may be used to implement the method 700. Additionally, although the method 700 is illustrated as a generally serial process, various aspects of the method 700 may be able to be executed in parallel.

In FIG. 7, in the method 700, at an operation 702, for example, the analysis module 206 can obtain information indicative that the measure of the cognitive state of the individual in the environment is greater than the cause-for-concern threshold.

At an operation 704, for example, the controller module 208 can cause a response intended to reduce the measure to be less than the cause-for-concern threshold. The response can include a presentation of an image to produce an augmented reality for the environment. Additionally or alternatively, for example, if the individual is operating a machine, then the response can include a change to an operation of either a component of a stationary machine or a movement control component of a machine configured to move.

In a first implementation, for example, the individual can be a pedestrian. The environment can be an environment that includes traffic. For example, the measure of the cognitive state can be a measure of one or more of a degree of inattentiveness, a degree of fatigue, or the like. For example, the operation 702 can be performed by receiving, from the communications device 210, the information. Additionally or alternatively, for example, the operation 702 can be performed by determining that a continuous duration of time that the individual has been traversing the environment as the pedestrian is greater than a threshold continuous duration of time. The continuous duration of time can end at a current time. For example, the operation 704 can be performed by causing a communication to be sent to a roadside unit, in a vicinity of the individual, to cause the roadside unit to produce the presentation of the image to produce the augmented reality for the environment.

In a second implementation, for example, the individual can be a worker operating a stationary machine. The environment can be a site of the stationary machine in a manufacturing environment. For example, the measure of the cognitive state can be a measure of one or more of a degree of inattentiveness, a degree of fatigue, or the like. For example, the operation 702 can be performed by receiving, from the communications device 210, the information. Additionally or alternatively, for example, the operation 702 can be performed by determining, from an analysis of data received from the sensor 212, the information. Additionally or alternatively, for example, the operation 702 can be performed by determining that a continuous duration of time that the individual has been operating the stationary machine is greater than a threshold continuous duration of time. The continuous duration of time can end at a current time. For example, the operation 704 can be performed by causing a communication to be sent to the projector 216, which is in a vicinity of the individual, to cause the projector 216 to produce the presentation of the image to produce the augmented reality for the environment. Additionally or alternatively, for example, the operation 704 can be performed by causing the change to the operation of the component of the stationary machine.

In a third implementation, for example, the machine configured to move can be a vehicle and the individual can be an operator of the vehicle. The environment can be a location for which a degree of familiarity, of the individual, is less than a threshold degree of familiarity. For example, the measure of the cognitive state can be a measure of one or more of a degree of timidity, a degree of apprehension, or the like. For example, the operation 702 can be performed by receiving, from the communications device 210, the information. Additionally or alternatively, for example, the operation 702 can be performed by determining, from an analysis of data received from the sensor 212, the information. For example, the operation 704 can be performed by causing a communication to be sent to the projector 216, disposed on the vehicle, to cause the projector 216 to produce the presentation of the image to produce the augmented reality for the environment.

In a fourth implementation, for example, the machine configured to move can be a vehicle and the individual can be an operator of the vehicle. The environment can be a location for which a degree of familiarity, of the individual, is greater than a threshold degree of familiarity. For example, the measure of the cognitive state can be a measure of one or more of a degree of inattentiveness, a degree of fatigue, or the like. For example, the operation 702 can be performed by the operation 702 can be performed by receiving, from the communications device 210, the information. Additionally or alternatively, for example, the operation 702 can be performed by determining, from an analysis of data received from the sensor 212, the information. Additionally or alternatively, for example, the operation 702 can be performed by determining, based on a result of a performance of a test, the information. Additionally or alternatively, for example, the operation 702 can be performed by determining that a continuous duration of time that the individual has been operating the vehicle at the location is greater than a threshold continuous duration of time. The continuous duration of time can end at a current time. For example, in a first variation, the operation 704 can be performed by causing a communication to be sent to the projector 216, disposed on the vehicle, to cause the projector 216 to produce the presentation of the image to produce the augmented reality for the environment. Additionally or alternatively, for example, in a second variation, the operation 704 can be performed by causing the change to the operation of the movement control component of the vehicle.

In a first realization of the first variation, at an operation 706, for example, the augmented reality module 218 can determine a characteristic of the image to produce the augmented reality for the environment. For example, the characteristic can be one or more of a type, a size, a position in the environment of an appearance of the image, or the like. For example, the position in the environment of the image can be near a horizon. In an extension of the first realization of the first variation, for example, the image can include a sequence of images. For example, a characteristic of a later image, in the sequence of images, can be different from a characteristic of an earlier image in the sequence of images.

In a second realization of the first variation, for example, the image to produce the augmented reality for the environment can include an image that causes another vehicle to appear to be in a vicinity of the vehicle.

In a third realization of the first variation, for example, the environment can include another vehicle in a vicinity of the vehicle and the image to produce the augmented reality for the environment can include an image that causes an appearance of the other vehicle to be larger than an actual size of the other vehicle.

In a fourth realization of the first variation, for example, the vehicle can have a child safety seat and the image to produce the augmented reality for the environment can include an image of a child in the child safety seat.

In a first realization of the second variation, for example, the change to the operation of the movement control component of the vehicle can include a production of a vibration at an operator interface of the movement control component. In an extension of the first realization of the second variation, for example, a characteristic of the vibration can change with time. For example, the characteristic can include one or more of a rate of the vibration, an amount of energy in the vibration, or the like.

In a second realization of the second variation, for example, the change to the operation of the movement control component of the vehicle can include one or more of a change to a steering torque feedback or a change to a steering ratio. In an extension of the second realization of the second variation, for example, one or more of the change to the steering torque feedback or the change to the steering ratio can change with time.

In a third realization of the second variation, for example, the vehicle can have an adaptive cruise control (ACC) system and the change to the operation of the movement control component of the vehicle can include a change, in response to a communication sent to a controller of the adaptive cruise control (ACC) system, to a distance of a gap maintained between the vehicle and a preceding vehicle.

In a fourth realization of the second variation, for example, the vehicle can have a lane keeping assist (LKA) system and the change to the operation of the movement control component of the vehicle can include a change, in response to a communication sent to a controller of the lane keeping assist (LKA) system, to a degree of variation of a lateral position, within a lane, maintained by the lane keeping assist system.

In a fifth implementation, for example: (1) a first time can be a time at which the measure of the cognitive state of the individual in the environment becomes greater than the cause-for-concern threshold, (2) a second time can be a time at which the response is initiated, and (3) an interval can be a duration of time between the first time and the second time.

Additionally, at an operation 708, for example, the interval information module 220 can obtain information indicative of a measure of the interval. For example, the measure of the interval can be personalized for the individual.

For example, the operation 708 can be performed by receiving, from a computing platform via the communications device 210, the information indicative of the measure of the interval. For example, the computing platform can be a cloud computing platform. For example, the cloud computing platform can be configured to store information personalized for the individual. For example, such information can include the information indicative of the measure of the interval.

Additionally or alternatively, for example, the operation 708 can be performed by determining, using a machine learning technique, the information indicative of the measure of the interval. For example, the machine learning technique can process information personalized for the individual to determine the measure of the interval.

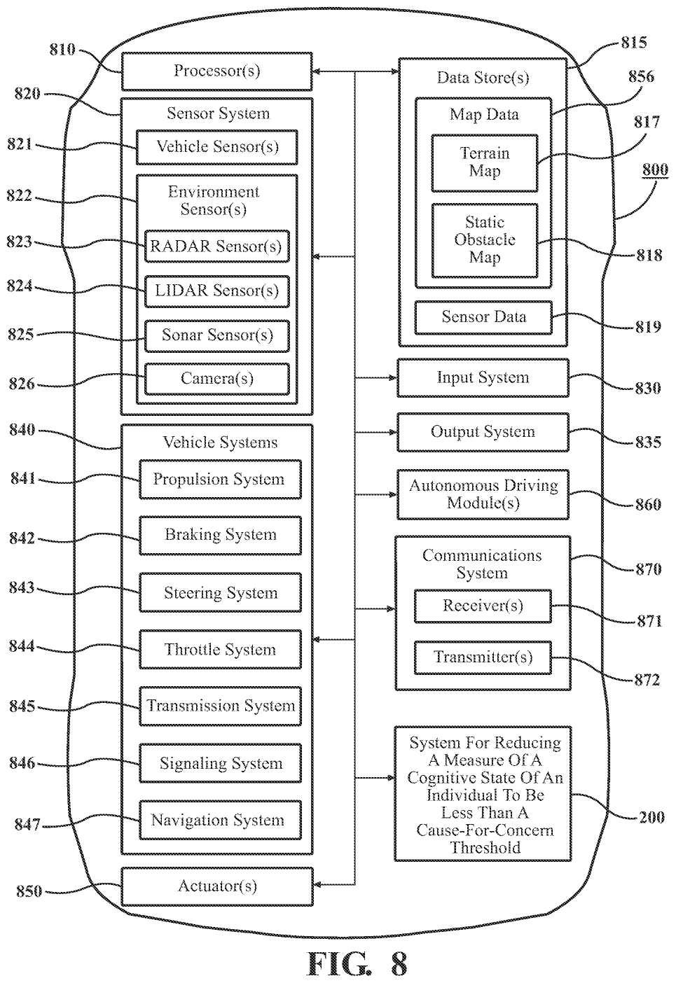

FIG. 8 includes a block diagram that illustrates an example of elements disposed on a vehicle 800, according to the disclosed technologies. As used herein, a “vehicle” can be any form of powered transport. In one or more implementations, the vehicle 800 can be an automobile. While arrangements described herein are with respect to automobiles, one of skill in the art understands, in light of the description herein, that embodiments are not limited to automobiles. For example, functions and/or operations of one or more of the vehicle 422 (illustrated in FIG. 4), the vehicle 500 (illustrated in FIG. 5), or the first vehicle 614 (illustrated in FIG. 6) can be realized by the vehicle 800.

The vehicle 800 can include various elements. The vehicle 800 can have any combination of the various elements illustrated in FIG. 8. In various embodiments, it may not be necessary for the vehicle 800 to include all of the elements illustrated in FIG. 8. Furthermore, the vehicle 800 can have elements in addition to those illustrated in FIG. 8. While the various elements are illustrated in FIG. 8 as being located within the vehicle 800, one or more of these elements can be located external to the vehicle 800. Furthermore, the elements illustrated may be physically separated by large distances. For example, as described, one or more components of the disclosed system can be implemented within the vehicle 800 while other components of the system can be implemented within a cloud-computing environment, as described below. For example, the elements can include one or more processors 810, one or more data stores 815, a sensor system 820, an input system 830, an output system 835, vehicle systems 840, one or more actuators 850, a communications system 870, and the system 200 for reducing a measure of a cognitive state of an individual in an environment to be less than a cause-for-concern threshold.

In one or more arrangements, the one or more processors 810 can be a main processor of the vehicle 800. For example, the one or more processors 810 can be an electronic control unit (ECU). For example, functions and/or operations of one or more of the processor 202 (illustrated in FIG. 2), the controller 214 (illustrated in FIG. 2), the processor 502 (illustrated in FIG. 5), the controller 526 (illustrated in FIG. 5), the controller 544 (illustrated in FIG. 5), or the controller 554 (illustrated in FIG. 5) can be realized by the one or more processors 810.

The one or more data stores 815 can store, for example, one or more types of data. The one or more data stores 815 can include volatile memory and/or non-volatile memory. For example, functions and/or operations of one or more of the memory 204 (illustrated in FIG. 2) or the memory 504 (illustrated in FIG. 5) can be realized by the one or more data stores 815. Examples of suitable memory for the one or more data stores 815 can include Random-Access Memory (RAM), flash memory, Read-Only Memory (ROM), Programmable Read-Only Memory (PROM), Erasable Programmable Read-Only Memory (EPROM), Electrically Erasable Programmable Read-Only Memory (EEPROM), registers, magnetic disks, optical disks, hard drives, any other suitable storage medium, or any combination thereof. The one or more data stores 815 can be a component of the one or more processors 810. Additionally or alternatively, the one or more data stores 815 can be operatively connected to the one or more processors 810 for use thereby. As used herein, “operatively connected” can include direct or indirect connections, including connections without direct physical contact. As used herein, a statement that a component can be “configured to” perform an operation can be understood to mean that the component requires no structural alterations, but merely needs to be placed into an operational state (e.g., be provided with electrical power, have an underlying operating system running, etc.) in order to perform the operation.

In one or more arrangements, the one or more data stores 815 can store map data 816. The map data 816 can include maps of one or more geographic areas. In some instances, the map data 816 can include information or data on roads, traffic control devices, road markings, structures, features, and/or landmarks in the one or more geographic areas. The map data 816 can be in any suitable form. In some instances, the map data 816 can include aerial views of an area. In some instances, the map data 816 can include ground views of an area, including 360-degree ground views. The map data 816 can include measurements, dimensions, distances, and/or information for one or more items included in the map data 816 and/or relative to other items included in the map data 816. The map data 816 can include a digital map with information about road geometry. The map data 816 can be high quality and/or highly detailed.

In one or more arrangements, the map data 816 can include one or more terrain maps 817. The one or more terrain maps 817 can include information about the ground, terrain, roads, surfaces, and/or other features of one or more geographic areas. The one or more terrain maps 817 can include elevation data of the one or more geographic areas. The map data 816 can be high quality and/or highly detailed. The one or more terrain maps 817 can define one or more ground surfaces, which can include paved roads, unpaved roads, land, and other things that define a ground surface.

In one or more arrangements, the map data 816 can include one or more static obstacle maps 818. The one or more static obstacle maps 818 can include information about one or more static obstacles located within one or more geographic areas. A “static obstacle” can be a physical object whose position does not change (or does not substantially change) over a period of time and/or whose size does not change (or does not substantially change) over a period of time. Examples of static obstacles can include trees, buildings, curbs, fences, railings, medians, utility poles, statues, monuments, signs, benches, furniture, mailboxes, large rocks, and hills. The static obstacles can be objects that extend above ground level. The one or more static obstacles included in the one or more static obstacle maps 818 can have location data, size data, dimension data, material data, and/or other data associated with them. The one or more static obstacle maps 818 can include measurements, dimensions, distances, and/or information for one or more static obstacles. The one or more static obstacle maps 818 can be high quality and/or highly detailed. The one or more static obstacle maps 818 can be updated to reflect changes within a mapped area.

In one or more arrangements, the one or more data stores 815 can store sensor data 819. As used herein, “sensor data” can refer to any information about the sensors with which the vehicle 800 can be equipped including the capabilities of and other information about such sensors. The sensor data 819 can relate to one or more sensors of the sensor system 820. For example, in one or more arrangements, the sensor data 819 can include information about one or more lidar sensors 824 of the sensor system 820.

In some arrangements, at least a portion of the map data 816 and/or the sensor data 819 can be located in one or more data stores 815 that are located onboard the vehicle 800. Additionally or alternatively, at least a portion of the map data 816 and/or the sensor data 819 can be located in one or more data stores 815 that are located remotely from the vehicle 800.

The sensor system 820 can include one or more sensors. As used herein, a “sensor” can refer to any device, component, and/or system that can detect and/or sense something. The one or more sensors can be configured to detect and/or sense in real-time. As used herein, the term “real-time” can refer to a level of processing responsiveness that is perceived by a user or system to be sufficiently immediate for a particular process or determination to be made, or that enables the processor to keep pace with some external process.

In arrangements in which the sensor system 820 includes a plurality of sensors, the sensors can work independently from each other. Alternatively, two or more of the sensors can work in combination with each other. In such a case, the two or more sensors can form a sensor network. The sensor system 820 and/or the one or more sensors can be operatively connected to the one or more processors 810, the one or more data stores 815, and/or another element of the vehicle 800 (including any of the elements illustrated in FIG. 8). The sensor system 820 can acquire data of at least a portion of the external environment of the vehicle 800 (e.g., nearby vehicles). The sensor system 820 can include any suitable type of sensor. Various examples of different types of sensors are described herein. However, one of skill in the art understands that the embodiments are not limited to the particular sensors described herein.

The sensor system 820 can include one or more vehicle sensors 821. The one or more vehicle sensors 821 can detect, determine, and/or sense information about the vehicle 800 itself. In one or more arrangements, the one or more vehicle sensors 821 can be configured to detect and/or sense position and orientation changes of the vehicle 800 such as, for example, based on inertial acceleration. In one or more arrangements, the one or more vehicle sensors 821 can include one or more accelerometers, one or more gyroscopes, an inertial measurement unit (IMU), a dead-reckoning system, a global navigation satellite system (GNSS), a global positioning system (GPS), a navigation system 847, and/or other suitable sensors. The one or more vehicle sensors 821 can be configured to detect and/or sense one or more characteristics of the vehicle 800. In one or more arrangements, the one or more vehicle sensors 821 can include a speedometer to determine a current speed of the vehicle 800. For example, functions and/or operations of one or more of the sensor 212 (illustrated in FIG. 2), the sensor 424 (e.g., a Global Navigation Satellite System (GNSS) sensor) (illustrated in FIG. 4), the sensor 506 (e.g., a Global Navigation Satellite System (GNSS) sensor) (illustrated in FIG. 5), or the sensor 564 (e.g., a ranging device) (illustrated in FIG. 5) can be realized by the one or more vehicle sensors 821.

Additionally or alternatively, the sensor system 820 can include one or more environment sensors 822 configured to acquire and/or sense driving environment data. As used herein, “driving environment data” can include data or information about the external environment in which a vehicle is located or one or more portions thereof. For example, the one or more environment sensors 822 can be configured to detect, quantify, and/or sense obstacles in at least a portion of the external environment of the vehicle 800 and/or information/data about such obstacles. Such obstacles may be stationary objects and/or dynamic objects. The one or more environment sensors 822 can be configured to detect, measure, quantify, and/or sense other things in the external environment of the vehicle 800 such as, for example, lane markers, signs, traffic lights, traffic signs, lane lines, crosswalks, curbs proximate the vehicle 800, off-road objects, etc.

Various examples of sensors of the sensor system 820 are described herein. The example sensors may be part of the one or more vehicle sensors 821 and/or the one or more environment sensors 822. However, one of skill in the art understands that the embodiments are not limited to the particular sensors described.

In one or more arrangements, the one or more environment sensors 822 can include one or more radar sensors 823, one or more lidar sensors 824, one or more sonar sensors 825, and/or one more cameras 826. In one or more arrangements, the one or more cameras 826 can be one or more high dynamic range (HDR) cameras or one or more infrared (IR) cameras. For example, the one or more cameras 826 can be used to record a reality of a state of an item of information that can appear in the digital map. For example, functions and/or operations of one or more of the sensor 510 (illustrated in FIG. 5), the left side-facing camera 520 (illustrated in FIG. 5), the forward-facing camera 522 (illustrated in FIG. 5), or the right side-facing camera 524 (illustrated in FIG. 5) can be realized by the one or more cameras 826.

The input system 830 can include any device, component, system, element, arrangement, or groups thereof that enable information/data to be entered into a machine. The input system 830 can receive an input from a vehicle passenger (e.g., a driver or a passenger). The output system 835 can include any device, component, system, element, arrangement, or groups thereof that enable information/data to be presented to a vehicle passenger (e.g., a driver or a passenger).

Various examples of the one or more vehicle systems 840 are illustrated in FIG. 8. However, one of skill in the art understands that the vehicle 800 can include more, fewer, or different vehicle systems. Although particular vehicle systems can be separately defined, each or any of the systems or portions thereof may be otherwise combined or segregated via hardware and/or software within the vehicle 800. For example, the one or more vehicle systems 840 can include a propulsion system 841, a braking system 842, a steering system 843, a throttle system 844, a transmission system 845, a signaling system 846, and/or the navigation system 847. Each of these systems can include one or more devices, components, and/or a combination thereof, now known or later developed. For example, functions and/or operations of the braking operator interface 538 (illustrated in FIG. 5) can be realized by the braking system 842. For example, functions and/or operations of the steering operator interface 512 (illustrated in FIG. 5) can be realized by the steering system 843. For example, functions and/or operations of the accelerating operator interface 532 (illustrated in FIG. 5) can be realized by the throttle system 844.

The navigation system 847 can include one or more devices, applications, and/or combinations thereof, now known or later developed, configured to determine the geographic location of the vehicle 800 and/or to determine a travel route for the vehicle 800. The navigation system 847 can include one or more mapping applications to determine a travel route for the vehicle 800. The navigation system 847 can include a global positioning system, a local positioning system, a geolocation system, and/or a combination thereof.

The one or more actuators 850 can be any element or combination of elements operable to modify, adjust, and/or alter one or more of the vehicle systems 840 or components thereof responsive to receiving signals or other inputs from the one or more processors 810. Any suitable actuator can be used. For example, the one or more actuators 850 can include motors, pneumatic actuators, hydraulic pistons, relays, solenoids, and/or piezoelectric actuators. For example, functions and/or operations of one or more of the steering operator interface haptic actuator 546 (illustrated in FIG. 5), the accelerating operator interface haptic actuator 548 (illustrated in FIG. 5), the braking operator interface haptic actuator 550 (illustrated in FIG. 5), or the joystick-like control lever haptic actuator 552 (illustrated in FIG. 5) can be realized by the one or more actuators 850.

The one or more processors 810 can be operatively connected to communicate with the various vehicle systems 840 and/or individual components thereof. For example, the one or more processors 810 can be in communication to send and/or receive information from the various vehicle systems 840 to control the movement, speed, maneuvering, heading, direction, etc. of the vehicle 800. The one or more processors 810 may control some or all of these vehicle systems 840.

The one or more processors 810 may be operable to control the navigation and/or maneuvering of the vehicle 800 by controlling one or more of the vehicle systems 840 and/or components thereof. The one or more processors 810 can cause the vehicle 800 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” can mean to make, force, compel, direct, command, instruct, and/or enable an event or action to occur or at least be in a state where such event or action may occur, either in a direct or indirect manner. The communications system 870 can include one or more receivers 871 and/or one or more transmitters 872. The communications system 870 can receive and transmit one or more messages through one or more wireless communications channels. For example, functions and/or operations of one or more of the communications device 426 (illustrated in FIG. 4) or the communications device 508 (illustrated in FIG. 5) can be realized by the communications system 870. For example, the one or more wireless communications channels can be in accordance with the Institute of Electrical and Electronics Engineers (IEEE) 802.11p standard to add wireless access in vehicular environments (WAVE) (the basis for Dedicated Short-Range Communications (DSRC)), the 3rd Generation Partnership Project (3GPP) Long-Term Evolution (LTE) Vehicle-to-Everything (V2X) (LTE-V2X) standard (including the LTE Uu interface between a mobile communication device and an Evolved Node B of the Universal Mobile Telecommunications System), the 3GPP fifth generation (5G) New Radio (NR) Vehicle-to-Everything (V2X) standard (including the 5G NR Uu interface), or the like. For example, the communications system 570 can include “connected vehicle” technology. “Connected vehicle” technology can include, for example, devices to exchange communications between a vehicle and other devices in a packet-switched network. Such other devices can include, for example, another vehicle (e.g., “Vehicle to Vehicle” (V2V) technology), roadside infrastructure (e.g., “Vehicle to Infrastructure” (V2I) technology), a cloud platform (e.g., “Vehicle to Cloud” (V2C) technology), a pedestrian (e.g., “Vehicle to Pedestrian” (V2P) technology), or a network (e.g., “Vehicle to Network” (V2N) technology. “Vehicle to Everything” (V2X) technology can integrate aspects of these individual communications technologies.

Moreover, the one or more processors 810, the one or more data stores 815, and the communications system 870 can be configured to one or more of form a micro cloud, participate as a member of a micro cloud, or perform a function of a leader of a mobile micro cloud. A micro cloud can be characterized by a distribution, among members of the micro cloud, of one or more of one or more computing resources or one or more data storage resources in order to collaborate on executing operations. The members can include at least connected vehicles.

The vehicle 800 can include one or more modules, at least some of which are described herein. The modules can be implemented as computer-readable program code that, when executed by the one or more processors 810, implement one or more of the various processes described herein. One or more of the modules can be a component of the one or more processors 810. Additionally or alternatively, one or more of the modules can be executed on and/or distributed among other processing systems to which the one or more processors 810 can be operatively connected. The modules can include instructions (e.g., program logic) executable by the one or more processors 810. Additionally or alternatively, the one or more data store 815 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Detailed embodiments are disclosed herein. However, one of skill in the art understands, in light of the description herein, that the disclosed embodiments are intended only as examples. Therefore, specific structural and functional details disclosed herein are not to be interpreted as limiting, but merely as a basis for the claims and as a representative basis for teaching one of skill in the art to variously employ the aspects herein in virtually any appropriately detailed structure. Furthermore, the terms and phrases used herein are not intended to be limiting but rather to provide an understandable description of possible implementations. Various embodiments are illustrated in FIGS. 1-8, but the embodiments are not limited to the illustrated structure or application.

The flowchart and block diagrams in the figures illustrate the architecture, functionality, and operation of possible implementations of systems, methods, and computer program products according to various embodiments. In this regard, each block in flowcharts or block diagrams may represent a module, segment, or portion of code, which comprises one or more executable instructions for implementing the specified logical function(s). One of skill in the art understands, in light of the description herein, that, in some alternative implementations, the functions described in a block may occur out of the order depicted by the figures. For example, two blocks depicted in succession may, in fact, be executed substantially concurrently, or the blocks may be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suitable. A typical combination of hardware and software can be a processing system with computer-readable program code that, when loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and that, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. As used herein, the phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples of the computer-readable storage medium would include, in a non-exhaustive list, the following: a portable computer diskette, a hard disk drive (HDD), a solid-state drive (SSD), a read-only memory (ROM), an erasable programmable read-only memory (EPROM or flash memory), a portable compact disc read-only memory (CD-ROM), a digital versatile disc (DVD), an optical storage device, a magnetic storage device, or any suitable combination of the foregoing. As used herein, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores such modules. The memory associated with a module may be a buffer or may be cache embedded within a processor, a random-access memory (RAM), a ROM, a flash memory, or another suitable electronic storage medium. In still further aspects, a module as used herein, may be implemented as an application-specific integrated circuit (ASIC), a hardware component of a system on a chip (SoC), a programmable logic array (PLA), or another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the disclosed technologies may be written in any combination of one or more programming languages, including an object-oriented programming language such as Java™, Smalltalk, C++, or the like, and conventional procedural programming languages such as the “C” programming language or similar programming languages. The program code may execute entirely on a user's computer, partly on a user's computer, as a stand-alone software package, partly on a user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . or . . . ” as used herein refers to and encompasses any and all possible combinations of one or more of the associated listed items. For example, the phrase “at least one of A, B, or C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing:
an analysis module including instructions that, when executed by the processor, cause the processor to obtain information indicative that a measure of a cognitive state of an individual in an environment is greater than a cause-for-concern threshold; and
a controller module including instructions that, when executed by the processor, cause the processor to cause a response intended to reduce the measure to be less than the cause-for-concern threshold, the response including at least one of:
a presentation of an image to produce an augmented reality for the environment, or
if the individual is operating a machine, then a change to an operation of:
a component of a stationary machine, or
a movement control component of a machine configured to move.

2. The system of claim 1, wherein:
the machine configured to move is a vehicle, and
the individual is being an operator of the vehicle.

3. The system of claim 2, wherein:
the measure of the cognitive state is a measure of at least one of a degree of timidity or a degree of apprehension,
the environment is a location for which a degree of familiarity, of the individual, is less than a threshold degree of familiarity,
the instructions to obtain the information include at least one of:
instructions to receive, from a communications device, the information, or
instructions to determine, from an analysis of data received from a sensor, the information; and
the instructions to cause the response include instructions to cause a communication to be sent to a projector, disposed on the vehicle, to cause the projector to produce the presentation of the image to produce the augmented reality for the environment.

4. The system of claim 2, wherein:
the measure of the cognitive state is a measure of at least one of a degree of inattentiveness or a degree of fatigue,
the environment is a location for which a degree of familiarity, of the individual, is greater than a threshold degree of familiarity,
the instructions to obtain the information include at least one of:
instructions to receive, from a communications device, the information,
instructions to determine, from an analysis of data received from a sensor, the information,
instructions to determine, based on a result of a performance of a test, the information, or
instructions to determine that a continuous duration of time that the individual has been operating the vehicle at the location is greater than a threshold continuous duration of time, the continuous duration of time ending with a current time; and
the instructions to cause the response include instructions to cause at least one of:
a communication to be sent to a projector, disposed on the vehicle, to cause the projector to produce the presentation of the image to produce the augmented reality for the environment, or
the change to the operation of the movement control component of the vehicle.

5. The system of claim 4, wherein the memory further stores an augmented reality module including instructions that, when executed by the processor, cause the processor to determine a characteristic of the image, the characteristic being at least one of a type, a size, or a position in the environment of an appearance of the image.

6. The system of claim 5, wherein the position in the environment is near a horizon.

7. The system of claim 5, wherein:
the image comprises a sequence of images, and
a characteristic of a later image, in the sequence of images, is different from a characteristic of an earlier image in the sequence of images.

8. The system of claim 4, wherein the image to produce the augmented reality for the environment comprises an image that causes another vehicle to appear to be in a vicinity of the vehicle.

9. The system of claim 4, wherein:
the environment includes another vehicle in a vicinity of the vehicle, and
the image to produce the augmented reality for the environment comprises an image that causes an appearance of the other vehicle to be larger than an actual size of the other vehicle.

10. The system of claim 4, wherein:
the vehicle has a child safety seat, and
the image to produce the augmented reality for the environment comprises an image of a child in the child safety seat.

11. The system of claim 4, wherein the change to the operation of the movement control component of the vehicle comprises a production of a vibration at an operator interface of the movement control component.

12. The system of claim 4, wherein the change to the operation of the movement control component of the vehicle comprises at least one of a change to a steering torque feedback or a change to a steering ratio.

13. The system of claim 4, wherein:
the vehicle has an adaptive cruise control system, and
the change to the operation of the movement control component of the vehicle comprises a change, in response to a communication sent to a controller of the adaptive cruise control system, to a distance of a gap maintained between the vehicle and a preceding vehicle.

14. The system of claim 4, wherein:
the vehicle has a lane keeping assist system, and
the change to the operation of the movement control component of the vehicle comprises a change, in response to a communication sent to a controller of the lane keeping assist system, to a degree of variation of a lateral position, within a lane, maintained by the lane keeping assist system.

15. The system of claim 1, wherein:
a first time is a time at which the measure of the cognitive state of the individual in the environment becomes greater than the cause-for-concern threshold,
a second time is a time at which the response is initiated,
an interval is a duration of time between the first time and the second time, and
the memory further stores an interval information module including instructions that, when executed by the processor, cause the processor to obtain information indicative of a measure of the interval, the measure of the interval being personalized for the individual.

16. The system of claim 15, wherein the instructions to obtain the information indicative of the measure of the interval include instructions to determine, using a machine learning technique, the information indicative of the measure of the interval.

17. A method, comprising:
obtaining, by a processor, information indicative that a measure of a cognitive state of an individual in an environment is greater than a cause-for-concern threshold; and
causing, by the processor, a response intended to reduce the measure to be less than the cause-for-concern threshold, the response including at least one of:
a presentation of an image to produce an augmented reality for the environment, or
if the individual is operating a machine, then a change to an operation of:
a component of a stationary machine, or
a movement control component of a machine configured to move.

18. The method of claim 17, wherein:
the individual is being a pedestrian,
the environment is an environment that includes traffic,
the measure of the cognitive state is a measure of at least one of a degree of inattentiveness or a degree of fatigue,
the obtaining the information comprises at least one of:
receiving, from a communications device, the information, or
determining that a continuous duration of time that the individual has been traversing the environment as the pedestrian is greater than a threshold continuous duration of time, the continuous duration of time ending at a current time, and
the causing the response comprises causing a communication to be sent to a roadside unit, in a vicinity of the individual, to cause the roadside unit to produce the presentation of the image to produce the augmented reality for the environment.

19. The method of claim 17, wherein:
the individual is being a worker operating the stationary machine,
the environment is a site of the stationary machine in a manufacturing environment,
the measure of the cognitive state is a measure of at least one of a degree of inattentiveness or a degree of fatigue,
the obtaining the information comprises at least one of:
receiving, from a communications device, the information,
determining, from an analysis of data received from a sensor, the information, or
determining that a continuous duration of time that the individual has been operating the stationary machine is greater than a threshold continuous duration of time, the continuous duration of time ending at a current time, and
the causing the response comprises causing at least one of:
a communication to be sent to a projector, in a vicinity of the individual, to cause the projector to produce the presentation of the image to produce the augmented reality for the environment, or
the change to the operation of the component of the stationary machine.

20. A non-transitory computer-readable medium for reducing a measure of a cognitive state of an individual in an environment to be less than a cause-for-concern threshold, the non-transitory computer-readable medium including instructions that, when executed by one or more processors, cause the one or more processors to:
obtain information indicative that the measure of the cognitive state of the individual in the environment is greater than the cause-for-concern threshold; and
cause a response intended to reduce the measure to be less than the cause-for-concern threshold, the response including at least one of:
a presentation of an image to produce an augmented reality for the environment, or
if the individual is operating a machine, then a change to an operation of:
a component of a stationary machine, or
a movement control component of a machine configured to move.
